(19) United States
(12) Patent Application Publication
(10) Pub. No.: US 2024/0069949 A1
(43) Pub. Date: Feb. 29, 2024

(54) APPLYING HYPERVISOR-BASED CONTAINERS TO A CLUSTER OF A CONTAINER ORCHESTRATION SYSTEM

(71) Applicant: International Business Machines Corporation, Armonk, NY (US)

(72) Inventor: Yohei Ueda, Shinagawa (JP)

(21) Appl. No.: 17/897,983

(22) Filed: Aug. 29, 2022

(51) Int. Cl. G06F 9/455; H04L 45/00; H04L 45/745; H04L 61/103

(52) U.S. Cl. CPC G06F 9/45558; H04L 45/34; H04L 45/745; H04L 61/103; G06F 2009/45587

(57) ABSTRACT

A computer-implemented method, system and computer program product for applying hypervisor-based containers to a cluster of a container orchestration system. A container runtime of a worker node in the cluster of the container orchestration system issues a request to create a sandbox environment to store a pod containing one or more containers. Upon creating the sandbox environment for each pod to improve isolation, a network tunnel is created between the worker node and the sandbox environment without packet encapsulation in which the sandbox environment shares the same Internet Protocol (IP) address as the other end of the network tunnel in the worker node. Packets may then be routed (forwarded) from the worker node to the sandbox environment via the network tunnel using source routing. By utilizing such source routing, packet looping is prevented. In this manner, hypervisor-based containers may be applied to a cluster of a container orchestration system.

### TECHNICAL FIELD

The present disclosure relates generally to container orchestration systems, and more particularly to applying hypervisor-based containers to a cluster (e.g., Kubernetes® cluster) of a container orchestration system (e.g., Kubernetes®, Apache® Mesos, Amazon ECS®), where such a cluster may run on an IaaS (Infrastructure as a Service) cloud.

### BACKGROUND

Container orchestration systems (e.g., Kubernetes®) automate the deployment, management, scaling and networking of containers. A container refers to a standard unit of software that packages up code and all its dependencies so that the application runs quickly and reliably from one computing environment to another.

### SUMMARY

In one embodiment of the present disclosure, a computer-implemented method for applying hypervisor-based containers to a cluster of a container orchestration system comprises issuing a request to create a sandbox environment to store a pod containing one or more containers. The method further comprises creating a network tunnel between a worker node of the cluster of the container orchestration system and the sandbox environment without packet encapsulation. The method additionally comprises routing packets from the worker node to the sandbox environment via the network tunnel using source routing.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 illustrates creating a sandbox environment in accordance with an embodiment of the present disclosure;

FIG. 3 illustrates network tunneling without packet encapsulation in accordance with an embodiment of the present disclosure;

FIG. 4 illustrates an embodiment of the present disclosure of the hardware configuration of the container orchestration system which is representative of a hardware environment for practicing the present disclosure;

FIG. 5 is a flowchart of a method for establishing a network tunnel between the worker node and the sandbox environment in accordance with an embodiment of the present disclosure; and

FIG. 6 is a flowchart of a method for applying hypervisor-based containers to a cluster of a container orchestration system in accordance with an embodiment of the present disclosure.

### DETAILED DESCRIPTION

As stated in the Background section, container orchestration systems (e.g., Kubernetes®) automate the deployment, management, scaling and networking of containers. A container refers to a standard unit of software that packages up code and all its dependencies so that the application runs quickly and reliably from one computing environment to another.

These containers may be run in “pods” by the container orchestration systems. A “pod” is a group of one or more containers, which may be deployed to a node. All the containers in the pod share an Internet Protocol (IP) address, inter-process communication (IPC), hostname and other resources.

Such pods may reside in a node, referred to as a “worker node.” A worker node is used to run containerized applications and handle networking to ensure that traffic between applications across the cluster and from outside of the cluster can be properly facilitated. A “cluster,” as used herein, refers to a set of nodes (e.g., worker nodes) that run containerized applications (containerized applications package an application with its dependencies and necessary services). Such clusters may run on an IaaS (Infrastructure as a Service) cloud.

Furthermore, such worker nodes may include a container runtime. A “container runtime,” as used herein, refers to a low-level component that creates and runs containers. One such container runtime is a hypervisor-based container runtime (e.g., Kata Container®). A “hypervisor-based container” (e.g., runV), as used herein, refers to hypervisor-based implementations of the Open Container Initiative (OCI) runtime specification. They achieve higher isolation while maintaining the benefits of application packaging and immutable infrastructure.

Such hypervisor-based container runtimes may create a dedicated virtual machine, such as a sandbox virtual machine, for each pod in order to improve isolation. A sandbox virtual machine is an isolated virtual machine. Such an isolated virtual machine may be utilized to execute potentially unsafe software code without affecting network resources or local applications.

However, in situations in which the worker nodes are virtual machine instances, such as in an IaaS (Infrastructure as a Service) cloud, high-overhead nested virtualization is required in order to create such sandbox virtual machines thereby negatively impacting performance.

If, however, the worker nodes are bare machines (computers executing instructions directly on logic hardware without an intervening operating system), nested virtualization is no longer necessary. Unfortunately, offerings of bare machine instances are usually limited, expensive and less flexible in comparison to virtual machines instances.

As a result, there is not currently a means for effectively applying hypervisor-based containers to a cluster (e.g., Kubernetes® cluster) of a container orchestration system (e.g., Kubernetes®, Apache® Mesos, Amazon ECS®), where such a cluster may run on an IaaS (Infrastructure as a Service) cloud.

The embodiments of the present disclosure provide a means for applying hypervisor-based containers to a cluster (e.g., Kubernetes® cluster) of a container orchestration system (e.g., Kubernetes®, Apache® Mesos, Amazon ECS®), where such a cluster may run on an IaaS (Infrastructure as a Service) cloud, by creating a network tunnel between a worker node and a sandbox environment (e.g., sandbox virtual machine instance) without packet encapsulation in which the packets are routed from the worker node to the sandbox environment via the network tunnel using source routing. A more detailed description of these and other features will be provided below.

In some embodiments of the present disclosure, the present disclosure comprises a computer-implemented method, system and computer program product for applying hypervisor-based containers to a cluster of a container orchestration system. In one embodiment of the present disclosure, a container runtime of a worker node in the cluster of the container orchestration system issues a request to create a sandbox environment to store a pod containing one or more containers. A “cluster,” as used herein, refers to a set of worker nodes (e.g., worker node virtual machine instances) that run containerized applications (containerized applications package an application with its dependencies and necessary services). A “container runtime,” as used herein, refers to a low-level component that creates and runs containers. One such container runtime is a hypervisor-based container runtime (e.g., Kata Container®). A “hypervisor-based container” (e.g., runV), as used herein, refers to hypervisor-based higher isolation while maintaining the benefits of application packaging and immutable infrastructure. In one embodiment, a sandbox environment (e.g., isolated virtual machine) is created for each pod in order to improve isolation. A “pod,” as used herein, refers to an encapsulation of a group of one or more containers deployed on the sandbox environment. Upon creating a sandbox environment (e.g., sandbox virtual machine instance) for each pod to improve isolation, a network tunnel is created between the worker node and the sandbox environment without packet encapsulation in which the sandbox environment shares the same Internet Protocol (IP) address as the other end of the network tunnel in the worker node. Packets may then be routed (forwarded) from the worker node to the sandbox environment via the network tunnel using source routing. In one embodiment, such source routing is performed using a routing table. In one embodiment, the routing table includes the source (source of packet), the destination (IP address of the packet's final destination), and the next hop (IP address or virtual Ethernet device to which the packet is forwarded). By utilizing such source routing, packet looping is prevented. That is, by utilizing such source routing, packets are able to be sent to the sandbox environment as opposed to being returned to the pod network (enables pods to communicate with one another) of the worker node. In this manner, hypervisor-based containers may be applied to a cluster (e.g., Kubernetes® cluster) of a container orchestration system, where such a cluster may run on an IaaS (Infrastructure as a Service) cloud.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

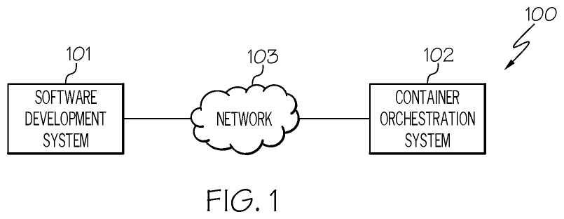

Referring now to the Figures in detail, FIG. 1 illustrates an embodiment of the present disclosure of a communication system 100 for practicing the principles of the present disclosure. Communication system 100 includes a software development system 101 connected to a container orchestration system 102 via a network 103.

Software development system 101 is a system utilized, such as by software developers, in the process of creating, designing, deploying and supporting software. Examples of such software development systems include, but not limited to, RAD Studio®, Embold®, Collaborator®, Studio 3T®, NetBeans®, Zend Studio®, Microsoft® Expression Studio, etc.

In one embodiment, software development system 101 is utilized by a software developer to deploy, manage, scale and network containers using container orchestration system 102 (e.g., Kubernetes®, Apache® Mesos, Amazon ECS®) via network 103.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

In one embodiment, container orchestration system 102 automates the deployment, management, scaling and networking of containers. A “container,” as used herein, refers to a standard unit of software that packages up code and all its dependencies so that the application runs quickly and reliably from one computing environment to another.

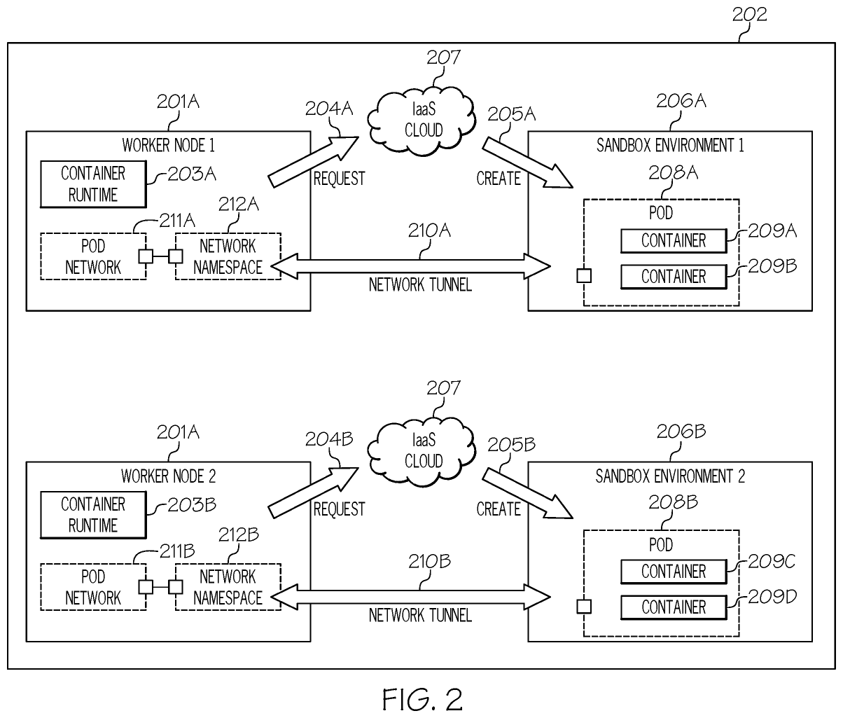

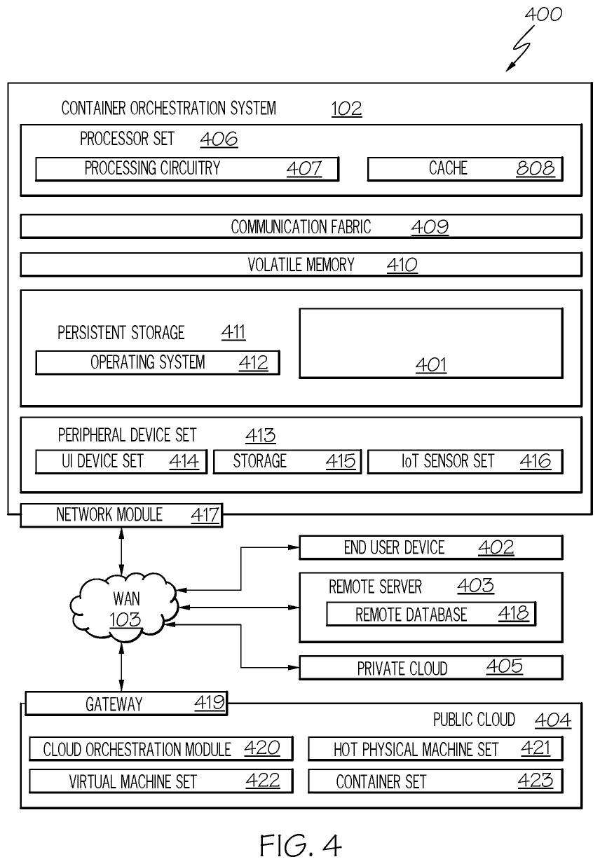

Furthermore, in one embodiment, container orchestration system 102 is configured to apply hypervisor-based containers to a cluster (e.g., Kubernetes® cluster) running on an IaaS (Infrastructure as a Service) cloud by creating a network tunnel between a worker node and a sandbox environment (e.g., sandbox virtual machine instance) without packet encapsulation in which the packets are routed from the worker node to the sandbox environment via the network tunnel using source routing as discussed below in connection with FIGS. 2-3 and 5-6. A description of the hardware configuration of container orchestration system 102 is provided further below in connection with FIG. 4.

System 100 is not to be limited in scope to any one particular network architecture. System 100 may include any number of software development systems 101, container orchestration systems 102 and networks 103.

Referring now to FIG. 2, FIG. 2 illustrates creating a sandbox environment (e.g., sandbox virtual machine instance), such as via an Infrastructure as a Service (IaaS) cloud, in accordance with an embodiment of the present disclosure.

As shown in FIG. 2, container orchestration system 102 includes one or more worker nodes 201A-201B (identified as “Worker Node 1,” and “Worker Node 2,” respectively, in FIG. 2). Worker nodes 201A-201B may collectively or individually be referred to as worker nodes 201 or worker node 201, respectively. “Worker node” 201, as used herein, is used to run containerized applications and handle networking to ensure that traffic between applications across cluster 202 and from outside of cluster 202 can be properly facilitated. A “cluster” 202, as used herein, refers to a set of worker nodes 201 (e.g., worker node virtual machine instances) that run containerized applications (containerized applications package an application with its dependencies and necessary services). Such clusters 202 may include one or more worker nodes 201. It is noted that while FIG. 2 illustrates cluster 202 containing a set of two worker nodes 201 that cluster 202 may contain any number of worker nodes 201. Furthermore, such clusters 202 may run on an IaaS (Infrastructure as a Service) cloud.

In one embodiment, worker node 201A, 201B includes a container runtime 203A, 203B, respectively. Container runtimes 203A-203B may collectively or individually be referred to as container runtimes 203 or container runtime 203, respectively. “Container runtime” 203, as used herein, refers to a low-level component that creates and runs containers. One such container runtime 203 is a hypervisor-based container runtime (e.g., Kata Container®). A “hypervisor-based container” (e.g., runV), as used herein, refers to hypervisor-based implementations of the Open Container Initiative (OCI) runtime specification. They achieve higher isolation while maintaining the benefits of application packaging and immutable infrastructure.

In one embodiment, container runtime 203A, 203B issues a request 204A, 204B, respectively, such as via a runtime task, to create (see elements 205A, 205B, respectively) a sandbox environment 206A, 206B, respectively (identified as “Sandbox Environment 1” and “Sandbox Environment 2,” respectively, in FIG. 2). Requests 204A-204B may collectively or individually be referred to as requests 204 or request 204, respectively. Elements 205A, 205B may collectively or individually be designated with element number 205. Furthermore, sandbox environments 206A-206B may collectively or individually be referred to as sandbox environments 206 or sandbox environment 206, respectively.

In one embodiment, such a request to create sandbox environment 206A, 206B by container runtime 203A, 203B, respectively, is via an Infrastructure as a Service (IaaS) cloud 207. In one embodiment, sandbox environment 206A, 206B is created for each pod 208A, 208B, respectively, in order to improve isolation. In one embodiment, sandbox environment 206 is an isolated virtual machine. Such an isolated virtual machine may be utilized to execute potentially unsafe software code without affecting network resources or local applications.

As discussed above, sandbox environment 206A, 206B is created for each pod 208A, 208B, respectively, in order to improve isolation. Pods 208A-208B may collectively or individually be referred to as pods 208 or pod 208, respectively. “Pod” 208, as used herein, refers to an encapsulation of a group of one or more containers deployed on sandbox environment 206. For example, pod 208A encapsulates the group of containers 209A-209B. Pod 208B encapsulates the group of containers 209C-209D. Containers 209A-209D may collectively or individually be referred to as containers 209 or container 209, respectively. All the containers, such as containers 209A-209B in pod 208A and containers 209C-209D in pod 208B share an Internet Protocol (IP) address, inter-process communication (IPC), hostname and other resources. While FIG. 2 illustrates two containers 209 in pod 208, it is noted that pod 208 may include any number of containers 209.

Upon creating a sandbox environment 206 (e.g., sandbox virtual machine instance) for each pod 208 to improve isolation, a network tunnel is created between worker node 201 and sandbox environment 206 in order to apply the hypervisor-based container (e.g., container runtime 203) to a cluster 202 of working nodes 201.

In one embodiment, container runtime 203A, 203B creates a network tunnel 210A, 210B, respectively, between worker node 201A, 201B and sandbox environment 206A, 206B, respectively, without packet encapsulation in which sandbox environment 206A, 206B shares the same Internet Protocol (IP) address as the other end of the network tunnel 210A, 210B, respectively, in worker node 201A, 201B, respectively, as discussed further below.

By having such a design as shown in FIG. 2, there is no nested virtualization and there are no bare machines to run sandbox environments 206 (e.g., sandbox virtual machines).

In one embodiment, packets received by pod network 211A, 211B are forwarded to network tunnel 210A, 210B, respectively, via network namespace 212A, 212B, respectively. Pod networks 211A, 211B may collectively or individually be referred to as pod networks 211 or pod network 211, respectively. Network namespaces 212A, 212B may collectively or individually be referred to as network namespaces 212 or network namespace 212, respectively.

A pod network 211, as used herein, enables pods 208 to communicate with one another. Network namespace 212, as used herein, is a logical copy of the network stack from the host system, such as container orchestration system 102. In one embodiment, network namespace 212 is utilized for setting up containers 209 or virtual environments. Each namespace 212 has its own IP addresses, network interfaces, routing tables, and so forth.

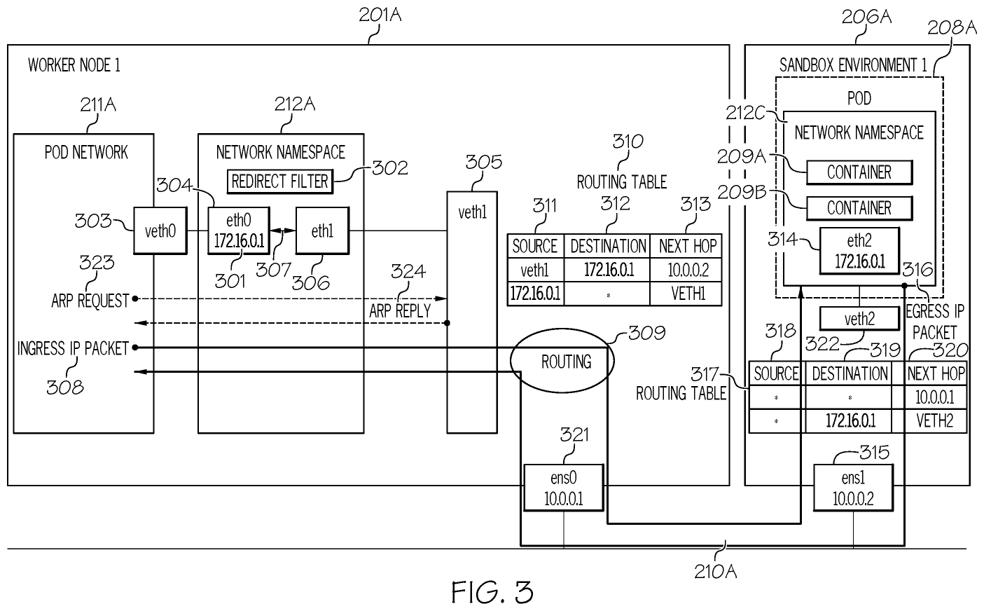

As previously discussed, embodiments of the present disclosure perform network tunneling without packet encapsulation. For example, with packet encapsulation, the header and payload of the packet goes inside the payload section of the surrounding packet. The original packet itself becomes the payload. Instead of performing such packet encapsulation, the embodiments of the present disclosure perform network tunneling using packet routing as discussed below in connection with FIG. 3. Furthermore, sandbox environment 206 is able to share the same IP address assigned to the other end of the network tunnel as discussed below in connection with FIG. 3.

FIG. 3 illustrates network tunneling without packet encapsulation in accordance with an embodiment of the present disclosure. It is noted that while FIG. 3 only illustrates network tunneling between worker node 201A and sandbox environment 206A that the principles of the present disclosure discussed herein also apply to network tunneling between other worker nodes 201 and sandbox environments 206.

Referring to FIG. 3, in conjunction with FIGS. 1-2, the pod IP address 301 (e.g., 172.16.0.1) which is assigned by container orchestration system 102 is used by containers 209 since sandbox environment 206 can use the same pod IP address. As a result, a single IP address may be used for network tunnel 210. In one embodiment, such an IP address (pod IP address) is assigned by container orchestration system 102.

In one embodiment, network namespace 212A includes a redirect filter 302, such as a Linux® traffic control (TC) redirect filter, configured to forward packets, such as IP packets, from pod network 211A to network tunnel 210A. That is, redirect filter 302 redirects packets, such as IP packets, from an original network interface to network tunnel 210. For example, IP packets are transferred from pod network 211A to network namespace 212A via virtual Ethernet device (veth0) 303. The IP packet is received by redirect filter 302 via Ethernet interface (eth0) 304 and directed to virtual Ethernet device (veth1) 305 via Ethernet interface (eth1) 306 by redirect filter 302 (as shown in arrow 307).

Such packets, such as ingress IP packets 308, may be forwarded from worker node 201A to sandbox environment 206A via network tunnel 210A using source routing 309. In one embodiment, such source routing 309 is performed using a routing table 310 which prevents packet looping even when the same IP address is used at both ends of network tunnel 210. That is, without source routing 309, packets would not be able to be sent to sandbox environment 206, but instead, would be returned to pod network 211. In one embodiment, routing table 310 is stored in the host network namespace of worker node 201.

As illustrated in FIG. 3, routing table 310 includes the source 311 (source of packet, such as the virtual Ethernet device or the IP address of the source of the packet), destination 312 (IP address of the packet's final destination) and next hop 313 (IP address or virtual Ethernet device to which the packet is forwarded). For example, as shown in FIG. 3, the source of ingress IP packet 308 was veth1 305 with a destination of IP address 172.16.0.1, which corresponds to the Ethernet interface (eth2) 314 within network namespace 212C of pod 208A of sandbox environment 206A. Prior to being received by Ethernet interface (eth2) 314 within network namespace 212C of pod 208A, the packet is forwarded to IP address 10.0.0.2, which corresponds to network interface (ens1) 315. In another example, the source of ingress IP packet 308 corresponds to IP address 172.16.0.1, which corresponds to Ethernet interface (eth0) 304 of network namespace 212A, which will be forwarded to sandbox environment 206A via virtual Ethernet device (veth1) 305.

Furthermore, as shown in FIG. 3, egress IP packets 316 may be forwarded to work node 201A from sandbox environment 206A via network tunnel 210A using source routing, such as via routing table 317. In one embodiment, routing table 317 is stored in the host network namespace of sandbox environment 206A.

As illustrated in FIG. 3, routing table 317 includes the source 318 (source of packet, such as the virtual Ethernet device or the IP address of the source of the packet), destination 319 (IP address of the packet's final destination) and next hop 320 (IP address or virtual Ethernet device to which the packet is forwarded). For example, as shown in FIG. 3, egress IP packet 316 may be forwarded to worker node 201A from sandbox environment 206A by forwarding the IP packet 316 to IP address 10.0.0.1, which corresponds to network interface (ens0) 321. In another example, IP packet 316 will be forwarded to the destination with the IP address of 172.16.0.1, which corresponds to Ethernet interface 304 of network namespace 212A after being forwarded to virtual Ethernet device (veth2) 322.

In this manner, network tunneling can be enacted without packet encapsulation thereby eliminating the use of packet header bytes (e.g., 50 bytes), such as to store the User Datagram Protocol (UDP) header, the Virtual Extensible LAN (VxLAN) header for the tunneling method of VxLAN, etc.

Furthermore, by enacting network tunneling without packet encapsulation, there are no compatibility issues due to a small MTU (maximum transmission unit) size.

Additionally, by enacting network tunneling without packet encapsulation using the principles of the present disclosure versus other tunneling methods, such as VxLAN, better network throughput is achieved.

In one embodiment, redirect filter 302 forwards address resolution protocol (ARP) packets (ARP requests 323) from pod network 211 to proxy server 305 as discussed below. Ethernet interface (etho) 304 does not respond to ARP requests 323 from pod network 211 because redirect filter 302 is configured on Ethernet interface (etho) 304. Instead, ARP requests 323 from pod network 211, such as pod network 211A, are responded (ARP reply 324) by the worker-side end of network tunnel 210A, such as by veth1 305, which may correspond to a proxy server.

An ARP request 323 is used to find the media access control address of the device corresponding to its IP address. In one embodiment, proxy server 305 responds (ARP reply 324) to such ARP requests 323 using a proxy ARP. Proxy ARP, as used herein, is a technique by which proxy server 305 answers the ARP queries for an IP address that is not on that network. In this manner, ARP requests 323 are responded (ARP reply 324) by proxy server 305 without forwarding the non-routable ARP packets to the other end of network tunnel 210.

In one embodiment, proxy server 305 is aware of the location of the traffic's destination and offers its own media access control (MAC) address as the (ostensibly final) destination. The traffic directed to the proxy address may then be routed by proxy server 305 to the intended destination via another interface or via a tunnel.

Prior to the discussion of the method for applying hypervisor-based containers to a cluster (e.g., Kubernetes® cluster) of a container orchestration system (e.g., Kubernetes®, Apache® Mesos, Amazon ECS®), where such a cluster may run on an IaaS (Infrastructure as a Service) cloud, using the features discussed in FIGS. 2-3, a description of an embodiment of a hardware configuration of container orchestration system 102 is provided below in connection with FIG. 4.

Referring now to FIG. 4, in conjunction with FIG. 1, FIG. 4 illustrates an embodiment of the present disclosure of the hardware configuration of container orchestration system 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 400 contains an example of an environment for the execution of at least some of the computer code 401 involved in performing the inventive methods, such as applying hypervisor-based containers to a cluster (e.g., Kubernetes® cluster) of a container orchestration system (e.g., Kubernetes®, Apache® Mesos, Amazon ECS®) running on an IaaS (Infrastructure as a Service) cloud. In addition to block 401, computing environment 400 includes, for example, container orchestration system 102, network 103, such as a wide area network (WAN), end user device (EUD) 402 (e.g., software development system 101), remote server 403, public cloud 404, and private cloud 405. In this embodiment, container orchestration system 102 includes processor set 406 (including processing circuitry 407 and cache 408), communication fabric 409, volatile memory 410, persistent storage 411 (including operating system 412 and block 401, as identified above), peripheral device set 413 (including user interface (UI) device set 414, storage 415, and Internet of Things (IoT) sensor set 416), and network module 417. Remote server 403 includes remote database 418. Public cloud 404 includes gateway 419, cloud orchestration module 420, host physical machine set 421, virtual machine set 422, and container set 423.

Container orchestration system 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 418. As is well understood in the art of computer technology, and depending upon the technology, performance of a computer-implemented method may be distributed among multiple computers and/or between multiple locations. On the other hand, in this presentation of computing environment 400, detailed discussion is focused on a single computer, specifically container orchestration system 102, to keep the presentation as simple as possible. Container orchestration system 102 may be located in a cloud, even though it is not shown in a cloud in FIG. 4. On the other hand, container orchestration system 102 is not required to be in a cloud except to any extent as may be affirmatively indicated.

Processor set 406 includes one, or more, computer processors of any type now known or to be developed in the future. Processing circuitry 407 may be distributed over multiple packages, for example, multiple, coordinated integrated circuit chips. Processing circuitry 407 may implement multiple processor threads and/or multiple processor cores. Cache 408 is memory that is located in the processor chip package(s) and is typically used for data or code that should be available for rapid access by the threads or cores running on processor set 406. Cache memories are typically organized into multiple levels depending upon relative proximity to the processing circuitry. Alternatively, some, or all, of the cache for the processor set may be located “off chip.” In some computing environments, processor set 406 may be designed for working with qubits and performing quantum computing.

Computer readable program instructions are typically loaded onto container orchestration system 102 to cause a series of operational steps to be performed by processor set 406 of container orchestration system 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 408 and the other storage media discussed below. The program instructions, and associated data, are accessed by processor set 406 to control and direct performance of the inventive methods. In computing environment 400, at least some of the instructions for performing the inventive methods may be stored in block 401 in persistent storage 411.

Communication fabric 409 is the signal conduction paths that allow the various components of container orchestration system 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 410 is any type of volatile memory now known or to be developed in the future. Examples include dynamic type random access memory (RAM) or static type RAM. Typically, the volatile memory is characterized by random access, but this is not required unless affirmatively indicated. In container orchestration system 102, the volatile memory 410 is located in a single package and is internal to container orchestration system 102, but, alternatively or additionally, the volatile memory may be distributed over multiple packages and/or located externally with respect to container orchestration system 102.

Persistent Storage 411 is any form of non-volatile storage for computers that is now known or to be developed in the future. The non-volatility of this storage means that the stored data is maintained regardless of whether power is being supplied to container orchestration system 102 and/or directly to persistent storage 411. Persistent storage 411 may be a read only memory (ROM), but typically at least a portion of the persistent storage allows writing of data, deletion of data and re-writing of data. Some familiar forms of persistent storage include magnetic disks and solid state storage devices. Operating system 412 may take several forms, such as various known proprietary operating systems or open source Portable Operating System Interface type operating systems that employ a kernel. The code included in block 401 typically includes at least some of the computer code involved in performing the inventive methods.

Peripheral device set 413 includes the set of peripheral devices of container orchestration system 102. Data communication connections between the peripheral devices and the other components of container orchestration system 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 414 may include components such as a display screen, speaker, microphone, wearable devices (such as goggles and smart watches), keyboard, mouse, printer, touchpad, game controllers, and haptic devices. Storage 415 is external storage, such as an external hard drive, or insertable storage, such as an SD card. Storage 415 may be persistent and/or volatile. In some embodiments, storage 415 may take the form of a quantum computing storage device for storing data in the form of qubits. In embodiments where container orchestration system 102 is required to have a large amount of storage (for example, where container orchestration system 102 locally stores and manages a large database) then this storage may be provided by peripheral storage devices designed for storing very large amounts of data, such as a storage area network (SAN) that is shared by multiple, geographically distributed computers. IoT sensor set 416 is made up of sensors that can be used in Internet of Things applications. For example, one sensor may be a thermometer and another sensor may be a motion detector.

Network module 417 is the collection of computer software, hardware, and firmware that allows container orchestration system 102 to communicate with other computers through WAN 103. Network module 417 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 417 are performed on the same physical hardware device. In other embodiments (for example, embodiments that utilize software-defined networking (SDN)), the control functions and the forwarding functions of network module 417 are performed on physically separate devices, such that the control functions manage several different network hardware devices. Computer readable program instructions for performing the inventive methods can typically be downloaded to container orchestration system 102 from an external computer or external storage device through a network adapter card or network interface included in network module 417.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 402 is any computer system that is used and controlled by an end user (for example, a customer of an enterprise that operates container orchestration system 102), and may take any of the forms discussed above in connection with container orchestration system 102. EUD 402 typically receives helpful and useful data from the operations of container orchestration system 102. For example, in a hypothetical case where container orchestration system 102 is designed to provide a recommendation to an end user, this recommendation would typically be communicated from network module 417 of container orchestration system 102 through WAN 103 to EUD 402. In this way, EUD 402 can display, or otherwise present, the recommendation to an end user. In some embodiments, EUD 402 may be a client device, such as thin client, heavy client, mainframe computer, desktop computer and so on.

Remote server 403 is any computer system that serves at least some data and/or functionality to container orchestration system 102. Remote server 403 may be controlled and used by the same entity that operates container orchestration system 102. Remote server 403 represents the machine(s) that collect and store helpful and useful data for use by other computers, such as container orchestration system 102. For example, in a hypothetical case where container orchestration system 102 is designed and programmed to provide a recommendation based on historical data, then this historical data may be provided to container orchestration system 102 from remote database 418 of remote server 403.

Public cloud 404 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 404 is performed by the computer hardware and/or software of cloud orchestration module 420. The computing resources provided by public cloud 404 are typically implemented by virtual computing environments that run on various computers making up the computers of host physical machine set 421, which is the universe of physical computers in and/or available to public cloud 404. The virtual computing environments (VCEs) typically take the form of virtual machines from virtual machine set 422 and/or containers from container set 423. It is understood that these VCEs may be stored as images and may be transferred among and between the various physical machine hosts, either as images or after instantiation of the VCE. Cloud orchestration module 420 manages the transfer and storage of images, deploys new instantiations of VCEs and manages active instantiations of VCE deployments. Gateway 419 is the collection of computer software, hardware, and firmware that allows public cloud 404 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 405 is similar to public cloud 404, except that the computing resources are only available for use by a single enterprise. While private cloud 405 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 404 and private cloud 405 are both part of a larger hybrid cloud.

Block 401 further includes the software components discussed above in connection with FIGS. 2-3 to apply hypervisor-based containers to a cluster (e.g., Kubernetes® cluster) of a container orchestration system, where such a cluster may run on an IaaS (Infrastructure as a Service) cloud. In one embodiment, such components may be implemented in hardware. The functions discussed above performed by such components are not generic computer functions. As a result, container orchestration system 102 is a particular machine that is the result of implementing specific, non-generic computer functions.

In one embodiment, the functionality of such software components of container orchestration system 102, including the functionality for applying hypervisor-based containers to a cluster (e.g., Kubernetes® cluster) of a container orchestration system running on an IaaS (Infrastructure as a Service) cloud may be embodied in an application specific integrated circuit.

As stated above, worker nodes of a container orchestration system (e.g., Kubernetes®) may include a container runtime. A “container runtime,” as used herein, refers to a low-level component that creates and runs containers. One such container runtime is a hypervisor-based container runtime (e.g., Kata Container®). A “hypervisor-based container” (e.g., runV), as used herein, refers to hypervisor-based implementations of the Open Container Initiative (OCI) runtime specification. They achieve higher isolation while maintaining the benefits of application packaging and immutable infrastructure. Such hypervisor-based container runtimes may create a dedicated virtual machine, such as a sandbox virtual machine, for each pod in order to improve isolation. A sandbox virtual machine is an isolated virtual machine. Such an isolated virtual machine may be utilized to execute potentially unsafe software code without affecting network resources or local applications. However, in situations in which the worker nodes are virtual machine instances, such as in an IaaS (Infrastructure as a Service) cloud, high-overhead nested virtualization is required in order to create such sandbox virtual machines thereby negatively impacting performance. If, however, the worker nodes are bare machines (computers executing instructions directly on logic hardware without an intervening operating system), nested virtualization is no longer necessary. Unfortunately, offerings of bare machine instances are usually limited, expensive and less flexible in comparison to virtual machines instances. As a result, there is not currently a means for effectively applying hypervisor-based containers to a cluster (e.g., Kubernetes® cluster) of a container orchestration system (e.g., Kubernetes®, Apache® Mesos, Amazon ECS®), where such a cluster may run on an IaaS (Infrastructure as a Service) cloud.

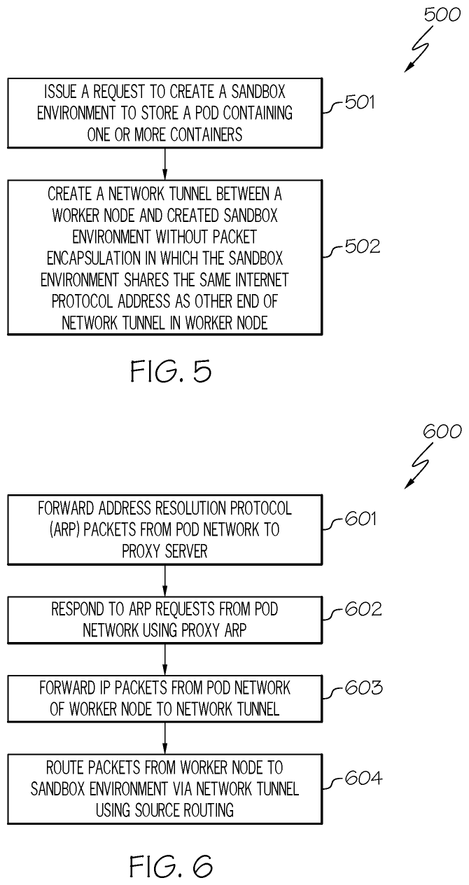

The embodiments of the present disclosure provide a means for applying hypervisor-based containers to a cluster (e.g., Kubernetes® cluster) of a container orchestration system (e.g., Kubernetes®, Apache® Mesos, Amazon ECS®), where such a cluster may run on an IaaS (Infrastructure as a Service) cloud, by creating a network tunnel between a worker node and a sandbox environment (e.g., sandbox virtual machine instance) without packet encapsulation in which the packets are routed from the worker node to the sandbox environment via the network tunnel using source routing as discussed below in connection with FIGS. 5-6. FIG. 5 is a flowchart of a method for establishing a network tunnel between the worker node and the sandbox environment. FIG. 6 is a flowchart of a method for applying hypervisor-based containers to a cluster of a container orchestration system.

As stated above, FIG. 5 is a flowchart of a method 500 for establishing a network tunnel between the worker node and the sandbox environment in accordance with an embodiment of the present disclosure.

Referring to FIG. 5, in conjunction with FIGS. 1-4, in operation 501, container runtime 203 issues a request 204 to create (see element 205 of FIG. 2) a sandbox environment 206 to store a pod 208 containing one or more containers 209.

As stated above, worker node 201 includes a container runtime 203. “Container runtime” 203, as used herein, refers to a low-level component that creates and runs containers. One such container runtime 203 is a hypervisor-based container runtime (e.g., Kata Container®). A “hypervisor-based container” (e.g., runV), as used herein, refers to hypervisor-based higher isolation while maintaining the benefits of application packaging and immutable infrastructure.

In one embodiment, container runtime 203 issues a request 204, such as via a runtime task, to create (see element 205) a sandbox environment 206. In one embodiment, such a request to create sandbox environment 206 by container runtime 203 is via an Infrastructure as a Service (IaaS) cloud 207. In one embodiment, sandbox environment 206 is created for each pod 208 in order to improve isolation. In one embodiment, sandbox environment 206 is an isolated virtual machine. Such an isolated virtual machine may be utilized to execute potentially unsafe software code without affecting network resources or local applications.

Furthermore, as discussed above, “pod” 208, as used herein, refers to an encapsulation of a group of one or more containers deployed on sandbox environment 206. All the containers 209 in pod 208 share an Internet Protocol (IP) address, inter-process communication (IPC), hostname and other resources.

Upon creating a sandbox environment 206 (e.g., sandbox virtual machine instance) for each pod 208 to improve isolation, a network tunnel is created between worker node 201 and sandbox environment 206 in order to apply the hypervisor-based container (e.g., container runtime 203) to a cluster 202 of working nodes 201.

In operation 502, container runtime 203 creates a network tunnel 210 between worker node 201 of a cluster 202 of container orchestration system 102 and sandbox environment 206 without packet encapsulation in which sandbox environment 206 shares the same Internet Protocol (IP) address as the other end of the network tunnel 210 in worker node 201.

By having such a design, such as discussed above in connection with FIG. 2, there is no nested virtualization and there is no bare machine to run the sandbox environment 206 (e.g., sandbox virtual machine).

Furthermore, as discussed above, in one embodiment, packets received by pod network 211 are forwarded to network tunnel 210 via network namespace 212. A pod network 211, as used herein, enables pods 208 to communicate with one another. Network namespace 212, as used herein, is a logical copy of the network stack from the host system, such as container orchestration system 102. In one embodiment, network namespace 212 is utilized for setting up containers 209 or virtual environments. Each namespace 212 has its own IP addresses, network interfaces, routing tables, and so forth.

A discussion regarding performing network tunneling without packet encapsulation is discussed below in connection with FIG. 6.

FIG. 6 is a flowchart of a method 600 for applying hypervisor-based containers to a cluster of a container orchestration system, where such a cluster may run on an IaaS cloud, in accordance with an embodiment of the present disclosure.

Referring to FIG. 6, in conjunction with FIGS. 1-5, in operation 601, redirect filter 302, such as a Linux® traffic control (TC) redirect filter, forwards address resolution protocol (ARP) packets 323 from pod network 211 to proxy server 305.

In operation 602, proxy server 305 responds (ARP reply 324) to address resolution protocol (ARP) requests 323 from pod network 211 using proxy ARP.

As stated above, in one embodiment, Ethernet interface (etho) 304 does not respond to address resolution protocol (ARP) requests 323 from pod network 211 because redirect filter 302 is configured on Ethernet interface (etho) 304. Instead, ARP requests 323 from pod network 211, such as pod network 211A, are responded (ARP reply 324) by the worker-side end of network tunnel 210A, such as by veth1 305, which may correspond to a proxy server.

An ARP request 323 is used to find the media access control address of the device corresponding to its IP address. In one embodiment, proxy server 305 responds (ARP reply 324) to such ARP requests 323 using a proxy ARP. Proxy ARP, as used herein, is a technique by which proxy server 305 answers the ARP queries for an IP address that is not on that network. In this manner, ARP requests 323 are responded (ARP reply 324) by proxy server 305 without forwarding the non-routable ARP packets to the other end of network tunnel 210.

In one embodiment, proxy server 305 is aware of the location of the traffic's destination and offers its own media access control (MAC) address as the (ostensibly final) destination. The traffic directed to the proxy address may then be routed by proxy server 305 to the intended destination via another interface or via a tunnel.

In operation 603, redirect filter 302, such as a Linux® traffic control (TC) redirect filter, forwards IP packets 308 from pod network 211 to network tunnel 210. That is, redirect filter 302 redirects IP packets 308 from an original network interface to network tunnel 210.

For example, IP packets 308 are transferred from pod network 211A to network namespace 212A via virtual Ethernet device (veth0) 303. IP packet 308 is received by redirect filter 302 via Ethernet interface (eth0) 304 and directed to virtual Ethernet device (veth1) 305 via Ethernet interface (eth1) 306 by redirect filter 302 (as shown in arrow 307).

In this manner, network tunneling can be enacted without packet encapsulation thereby eliminating the use of packet header bytes (e.g., 50 bytes), such as to store the User Datagram Protocol (UDP) header, the Virtual Extensible LAN (VxLAN) header for the tunneling method of VxLAN, etc.

Furthermore, by enacting network tunneling without packet encapsulation, there are no compatibility issues due to a small MTU (maximum transmission unit) size.

Additionally, by enacting network tunneling without packet encapsulation using the principles of the present disclosure versus other tunneling methods, such as VxLAN, better network throughput is achieved.

In operation 604, packets, such as ingress IP packets 308, are routed (forwarded) from worker node 201 to sandbox environment 206 via network tunnel 210 using source routing 309 as discussed below.

As discussed above, in one embodiment, such source routing 309 is performed using a routing table 310 which prevents packet looping even when the same IP address is used at both ends of the network tunnel 210. That is, without source routing 309, packets would not be able to be sent to sandbox environment 206, but instead, would be returned to pod network 211. In one embodiment, routing table 310 is stored in the host network namespace of worker node 201.

As illustrated in FIG. 3, routing table 310 includes the source 311 (source of packet, such as the virtual Ethernet device or the IP address of the source of the packet), destination 312 (IP address of the packet's final destination) and next hop 313 (IP address or virtual Ethernet device to which the packet is forwarded). For example, as shown in FIG. 3, the source of ingress IP packet 308 was veth1 305 with a destination of IP address 172.16.0.1, which corresponds to the Ethernet interface (eth2) 314 within network namespace 212C of pod 208A of sandbox environment 206A. Prior to being received by Ethernet interface (eth2) 314 within network namespace 212C of pod 208A, the packet is forwarded to IP address 10.0.0.2, which corresponds to network interface (ens1) 315. In another example, the source of ingress IP packet 308 corresponds to IP address 172.16.0.1, which corresponds to Ethernet interface (eth0) 304 of network namespace 212A, which will be forwarded to sandbox environment 206A via virtual Ethernet device (veth1) 305.

Furthermore, as shown in FIG. 3, egress IP packets 316 may be forwarded to work node 201 (e.g., work node 201A) from sandbox environment 206 (e.g., sandbox environment 206A) via network tunnel 210 (e.g., network tunnel 210A) using source routing, such as via routing table 317. In one embodiment, routing table 317 is stored in the host network namespace of sandbox environment 206A.

As illustrated in FIG. 3, routing table 317 includes the source 318 (source of packet, such as the virtual Ethernet device or the IP address of the source of the packet), destination 319 (IP address of the packet's final destination) and next hop 320 (IP address or virtual Ethernet device to which the packet is forwarded). For example, as shown in FIG. 3, egress IP packet 316 may be forwarded to worker node 201 (e.g., worker node 201A) from sandbox environment 206 (e.g., sandbox environment 206A) by forwarding the IP packet 316 to IP address 10.0.0.1, which corresponds to network interface (ens0) 321. In another example, IP packet 316 will be forwarded to the destination with the IP address of 172.16.0.1, which corresponds to Ethernet interface 304 of network namespace 212A after being forwarded to virtual Ethernet device (veth2) 322.

As a result of the foregoing, embodiments of the present disclosure provide a means for applying hypervisor-based containers to a cluster (e.g., Kubernetes® cluster) of a container orchestration system, where such a cluster may run on an IaaS (Infrastructure as a Service) cloud.

Furthermore, the principles of the present disclosure improve the technology or technical field involving container orchestration systems. As discussed above, worker nodes of a container orchestration system (e.g., Kubernetes®) may include a container runtime. A “container runtime,” as used herein, refers to a low-level component that creates and runs containers. One such container runtime is a hypervisor-based container runtime (e.g., Kata Container®). A “hypervisor-based container” (e.g., runV), as used herein, refers to hypervisor-based implementations of the Open Container Initiative (OCI) runtime specification. They achieve higher isolation while maintaining the benefits of application packaging and immutable infrastructure. Such hypervisor-based container runtimes may create a dedicated virtual machine, such as a sandbox virtual machine, for each pod in order to improve isolation. A sandbox virtual machine is an isolated virtual machine. Such an isolated virtual machine may be utilized to execute potentially unsafe software code without affecting network resources or local applications. However, in situations in which the worker nodes are virtual machine instances, such as in an IaaS (Infrastructure as a Service) cloud, high-overhead nested virtualization is required in order to create such sandbox virtual machines thereby negatively impacting performance. If, however, the worker nodes are bare machines (computers executing instructions directly on logic hardware without an intervening operating system), nested virtualization is no longer necessary. Unfortunately, offerings of bare machine instances are usually limited, expensive and less flexible in comparison to virtual machines instances. As a result, there is not currently a means for effectively applying hypervisor-based containers to a cluster (e.g., Kubernetes® cluster) of a container orchestration system (e.g., Kubernetes®, Apache® Mesos, Amazon ECS®), where such a cluster may run on an IaaS (Infrastructure as a Service) cloud.

Embodiments of the present disclosure improve such technology by having the container runtime of the worker node in the cluster of the container orchestration system issue a request to create a sandbox environment to store a pod containing one or more containers. A “cluster,” as used herein, refers to a set of worker nodes (e.g., worker node virtual machine instances) that run containerized applications (containerized applications package an application with its dependencies and necessary services). A “container runtime,” as used herein, refers to a low-level component that creates and runs containers. One such container runtime is a hypervisor-based container runtime (e.g., Kata Container®). A “hypervisor-based container” (e.g., runV), as used herein, refers to hypervisor-based implementations of the Open Container Initiative (OCI) runtime specification. They achieve higher isolation while maintaining the benefits of application packaging and immutable infrastructure. In one embodiment, a sandbox environment (e.g., isolated virtual machine) is created for each pod in order to improve isolation. A “pod,” as used herein, refers to an encapsulation of a group of one or more containers deployed on the sandbox environment. Upon creating a sandbox environment (e.g., sandbox virtual machine instance) for each pod to improve isolation, a network tunnel is created between the worker node and the sandbox environment without packet encapsulation in which the sandbox environment shares the same Internet Protocol (IP) address as the other end of the network tunnel in the worker node. Packets may then be routed (forwarded) from the worker node to the sandbox environment via the network tunnel using source routing. In one embodiment, such source routing is performed using a routing table. In one embodiment, the routing table includes the source (source of packet), the destination (IP address of the packet's final destination), and the next hop (IP address or virtual Ethernet device to which the packet is forwarded). By utilizing such source routing, packet looping is prevented. That is, by utilizing such source routing, packets are able to be sent to the sandbox environment as opposed to being returned to the pod network (enables pods to communicate with one another) of the worker node. In this manner, hypervisor-based containers may be applied to a cluster (e.g., Kubernetes® cluster) of a container orchestration system, where such a cluster may run on an IaaS (Infrastructure as a Service) cloud. Furthermore, in this manner, there is an improvement in the technical field involving container orchestration systems.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for applying hypervisor-based containers to a cluster of a container orchestration system, the method comprising:
issuing a request to create a sandbox environment to store a pod containing one or more containers;
creating a network tunnel between a worker node of said cluster of said container orchestration system and said sandbox environment without packet encapsulation; and
routing packets from said worker node to said sandbox environment via said network tunnel using source routing.

2. The method as recited in claim 1, wherein said sandbox environment shares a same Internet Protocol address as the other end of said network tunnel in said worker node.

3. The method as recited in claim 1 further comprising:
forwarding packets from a pod network in said worker node to said network tunnel, wherein said pod network enables pods to communicate with one another.

4. The method as recited in claim 3, wherein said packets are forwarded from said pod network in said worker node to said network tunnel using a redirect filter.

5. The method as recited in claim 1 further comprising:
responding to address resolution protocol requests from a pod network in said worker node using a proxy address resolution protocol.

6. The method as recited in claim 1, wherein said source routing is accomplished via a routing table.

7. The method as recited in claim 1, wherein said one or more containers of said pod share an Internet Protocol address, inter-process communication and a hostname.

8. A computer program product for applying hypervisor-based containers to a cluster of a container orchestration system, the computer program product comprising one or more computer readable storage mediums having program code embodied therewith, the program code comprising programming instructions for:
issuing a request to create a sandbox environment to store a pod containing one or more containers;
creating a network tunnel between a worker node of said cluster of said container orchestration system and said sandbox environment without packet encapsulation; and
routing packets from said worker node to said sandbox environment via said network tunnel using source routing.

9. The computer program product as recited in claim 8, wherein said sandbox environment shares a same Internet Protocol address as the other end of said network tunnel in said worker node.

10. The computer program product as recited in claim 8, wherein the program code further comprises the programming instructions for:
forwarding packets from a pod network in said worker node to said network tunnel, wherein said pod network enables pods to communicate with one another.

11. The computer program product as recited in claim 10, wherein said packets are forwarded from said pod network in said worker node to said network tunnel using a redirect filter.

12. The computer program product as recited in claim 8, wherein the program code further comprises the programming instructions for:
responding to address resolution protocol requests from a pod network in said worker node using a proxy address resolution protocol.

13. The computer program product as recited in claim 8, wherein said source routing is accomplished via a routing table.

14. The computer program product as recited in claim 8, wherein said one or more containers of said pod share an Internet Protocol address, inter-process communication and a hostname.

15. A system, comprising:
a memory for storing a computer program for applying hypervisor-based containers to a cluster of a container orchestration system; and
a processor connected to said memory, wherein said processor is configured to execute program instructions of the computer program comprising:
issuing a request to create a sandbox environment to store a pod containing one or more containers;
creating a network tunnel between a worker node of said cluster of said container orchestration system and said sandbox environment without packet encapsulation; and
routing packets from said worker node to said sandbox environment via said network tunnel using source routing.

16. The system as recited in claim 15, wherein said sandbox environment shares a same Internet Protocol address as the other end of said network tunnel in said worker node.

17. The system as recited in claim 15, wherein the program instructions of the computer program further comprise:
forwarding packets from a pod network in said worker node to said network tunnel, wherein said pod network enables pods to communicate with one another.

18. The system as recited in claim 17, wherein said packets are forwarded from said pod network in said worker node to said network tunnel using a redirect filter.

19. The system as recited in claim 15, wherein the program instructions of the computer program further comprise:
responding to address resolution protocol requests from a pod network in said worker node using a proxy address resolution protocol.

20. The system as recited in claim 15, wherein said source routing is accomplished via a routing table.
